(19) United States
(12) Patent Application Publication
(10) Pub. No.: US 2009/0056223 A1
(43) Pub. Date: Mar. 5, 2009

(54) QUENCH RING RIM AND METHODS FOR FABRICATING

(76) Inventors: Sunilkant A. Patel, Sugarland, TX (US); Monty Lee Harned, Sugarland, TX (US); Devin Richard Martin, Missouri City, TX (US); Shashishekara Sitharamarao Talya, Houston, TX (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 11/849,638

(22) Filed: Sep. 4, 2007

(51) Int. Cl. B01J 8/00; B23K 31/02

(52) U.S. Cl. 48/127.9; 228/176

(57) ABSTRACT

A quench ring rim and methods of fabrication are described. In one aspect, a method for fabricating a rim for use in a gasification system includes providing a hollow pipe, forming the pipe into a circular pipe, wherein a first end of the pipe is coupled to an opposite second end of the pipe, and cutting the pipe to form a rim having a desired circumference.

### BACKGROUND OF THE INVENTION

This invention relates generally to gasification systems, and more specifically to methods and apparatus for cooling synthetic gas (“syngas”) in gasifiers.

At least some known gasification systems convert a mixture of fuel, air or oxygen, steam, and/or limestone into an output of partially combusted gas, sometimes referred to as “syngas”. At least some known gasification systems use a separate gasifier, and a physically-large radiant cooler to gasify bottoms, to recover heat, and to remove solids from the syngas, to make the syngas useable by other systems. Further, at least some gasifiers include a quench chamber in which the syngas may be cooled. At least some known quench chambers include one or more quench rings that provide a constant film of water on the chamber walls and/or a dip tube.

At least some known methods of fabricating quench ring rims require a forged billet to be machined. However, such machining practices may increase the complexity, the capital expense, and the time necessary to complete the fabrication of such quench ring rims.

### BRIEF DESCRIPTION OF THE INVENTION

In one aspect, a method for fabricating a rim for use in a gasification system includes providing a hollow pipe, forming the pipe into a circular pipe, wherein a first end of the pipe is coupled to an opposite second end of the pipe, and cutting the pipe to form a rim having a desired circumference.

In another aspect, a method for fabricating a quench ring rim for use in a gasification system includes forming a hollow torroid by coupling a first end of a cylinder to a second opposite end of the cylinder, thereby defining an annular cavity within the torroid, and cutting the torroid to form an annular rim having a C-shaped cross-sectional profile.

In a further aspect, a quench ring rim for use in a gasification system includes an inner surface, an outer surface opposite said inner surface, a first rim edge, a second rim edge, an inner diameter defined by the radial distance between a bottom of said first rim edge and a top of said second rim edge, and an outer diameter defined by the radial distance between a top of said first rim edge and a bottom of said second rim edge. The rim is fabricated by providing a straight pipe having a desired length, diameter, and thickness, forming the pipe into a circular pipe by feeding the pipe through a pipe rolling machine, wherein a first end of the pipe is joined to a second end of the pipe, and wherein the first and second ends are sealed, and cutting the pipe along a desired circumference to form said rim having desired dimensions.

### BRIEF DESCRIPTION OF THE DRAWINGS

FIG. 1 is a schematic of an exemplary gasifier;

FIG. 2 is a schematic diagram of an exemplary straight pipe;

FIG. 3 is a top view diagram of an exemplary circular pipe; and

FIGS. 4A-4C are schematic diagrams of an exemplary quench ring rim that may be used with a gasifier as shown in FIG. 1 and that is fabricated from the straight pipe shown in FIG. 2 and the circular pipe shown in FIG. 3.

### DETAILED DESCRIPTION OF THE INVENTION

Synthetic gas, or “syngas,” as used herein refers to a gas mixture containing varying amounts of carbon monoxide and hydrogen. Syngas is formed by the gasification of a fuel containing carbon such that the fuel is converted to a gaseous product. Syngas may be created by steam catalytic oxidation of natural gas or liquid hydrocarbons to produce hydrogen. Alternatively, syngas may be created the gasification of coal and in some types of energy from waste gasification systems. Syngas may be used in power generation systems and/or for producing chemicals, such as ammonia or methanol. Syngas may also be used as an intermediate in producing synthetic fuel for use as a fuel or lubricant.

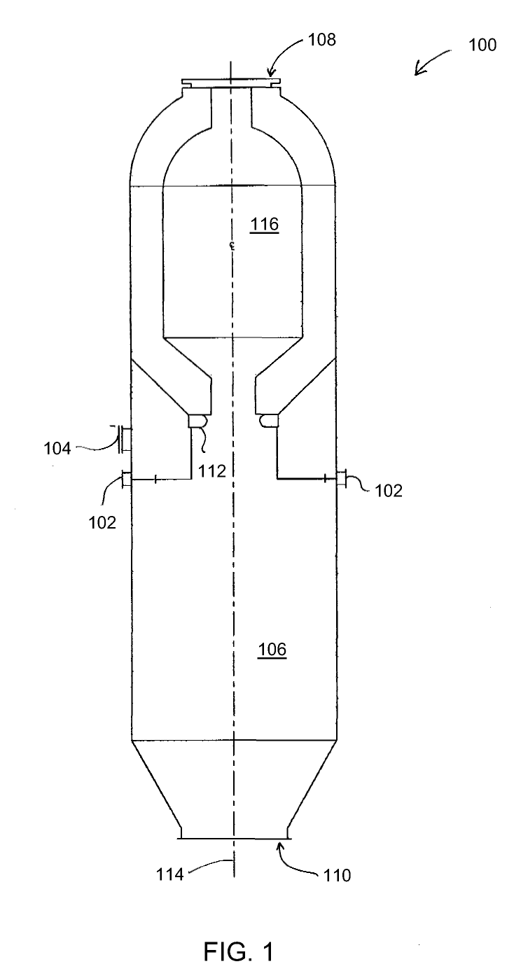

FIG. 1 is a schematic diagram of an exemplary known gasifier 100 that may be used in a power system and/or in a chemical manufacturing system. In the exemplary embodiment, gasifier 100 includes a first end 108 and an opposite second end 1 10. Gasifier 100 also includes a reaction chamber 116 and a quench section 106. Reaction chamber 116 and quench section 106 are aligned within gasifier 100 along a common axis 114 extending from first end 108 to second end 1 10. Gasifier 100 also includes at least one quench water inlet 102 coupled in flow communication with a water source (not shown). Alternative embodiments may use a cooling and scrubbing substance other than water. Gasifier 100 also includes at least one quenched gas outlet 104 coupled in flow communication with, for example, a syngas collection vessel (not shown). Additionally, gasifier 100 includes at least one quench ring 112 coupled in flow communication with the at least one quench water inlet 102.

During operation, gasifier 100 converts a mixture of, for example, fuel and oxygen into an output of syngas. In some known gasifiers 100, the generated syngas includes slag, carbon dioxide, and/or other contaminant gases. In the exemplary embodiment, the syngas generated by gasifier 100 is cooled and scrubbed in quench section 106 before being channeled through quenched gas outlet 104. The contaminants may be separated from the syngas in quench section 106 and may be vented to the atmosphere.

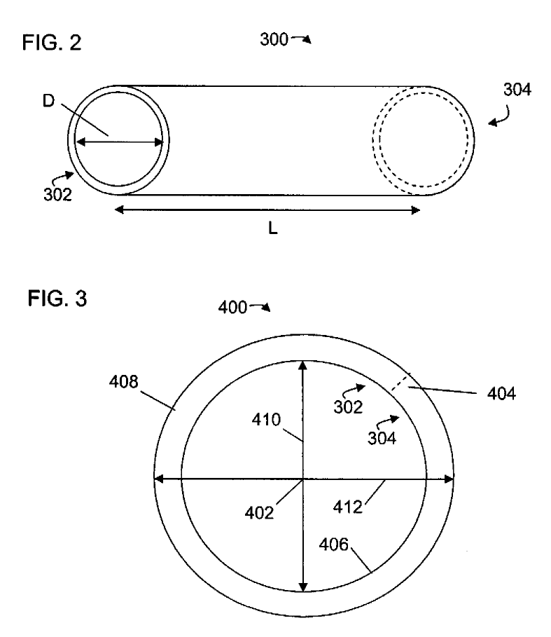

FIG. 2 is a diagram of an exemplary straight pipe 300 that may be used to fabricate a quench ring rim (not shown) for use with a gasifier, such as gasifier 100 (shown in FIG. 1). FIG. 3 is a top view diagram of a circular pipe 400 that may be used to fabricate a quench ring rim (not shown). Fabrication of a quench ring rim initially begins with a substantially straight pipe 300 that has a desired length L, a desired diameter D, and a desired thickness. Alternative embodiments may begin with a pipe or cylinder that is not straight. Pipe 300 also includes a first end 302 and a second end 304. In the exemplary embodiment, the fabrication of a quench ring rim begins with forming straight pipe 300 into a substantially circular pipe 400, shown in FIG. 3. In the exemplary embodiment, straight pipe 300 is formed into a substantially circular pipe or hollow torroid 400 using a pipe rolling machine. In alternative embodiments, other methods of forming pipe 400 may be used. Pipe 400 is formed with an inner diameter 410 and an outer diameter 412. Inner diameter 410 is measured from a center axis 402 of circular pipe 400 to an inner surface 406 of pipe 400. Similarly, outer diameter 412 is measured from center axis 402 to an outer surface 408 of pipe 400.

In the exemplary method, first and second ends 302 and 304, respectively, are then sealed to complete the formation of circular pipe 400 such that an annular cavity is defined within pipe 400. In the exemplary embodiment, a penetration weld is used to seal ends 302 and 304. In alternative embodiments, other methods of sealing may be used. As shown in FIG. 3, circular pipe 400 also includes a sealing joint 404. Sealing joint 404 is defined at the union of first and second ends 302 and 304, respectively, of pipe 300.

In the exemplary method, pipe 400, when sealed, is heat treated for a pre-determined amount of time and at a pre-determined temperature. In the exemplary method, the pre-determined amount of time is between ten and fifty minutes or, more specifically, twenty to forty minutes or, even more specifically, approximately thirty minutes. Heat treatment in alternative embodiments may occur for a different elapsed period of time. In the exemplary method, the pre-determined temperature is based on the material composition of circular pipe 400. In the exemplary embodiment, pipe 400 is substantially composed of a nickel-iron-chromium metal alloy such as commercially available Incoloy 825. Alternative embodiments may use different materials or combinations of materials. In the exemplary embodiment, pipe 400 is heated at a temperature between 1600 and 2000° F. or, more specifically between 1700 and 1900° F. Alternative embodiments may use a different temperature range or a particular temperature. Further, alternative embodiments may use a different basis for determining the appropriate heat treatment temperature.

In the exemplary method, following the heat treatment, pipe 400 is cooled. In the exemplary embodiment, the cooling method includes exposing circular pipe 400 to ambient air until a pre-determined amount of time has elapsed and/or until pipe 400 may is at or below a pre-determined temperature. Alternative embodiments may use other cooling methods such as, but not limited to, liquid quenching.

Once circular pipe 400 has cooled, a quench ring may be formed by cutting circular pipe 400 along a circumference (not shown). For example, circular pipe 400 may be, but is not limited to being, cut using water-jet cutting. Alternative methods may use other cutting methods such as, but not limited to, plasma cutting and/or oxyfuel cutting.

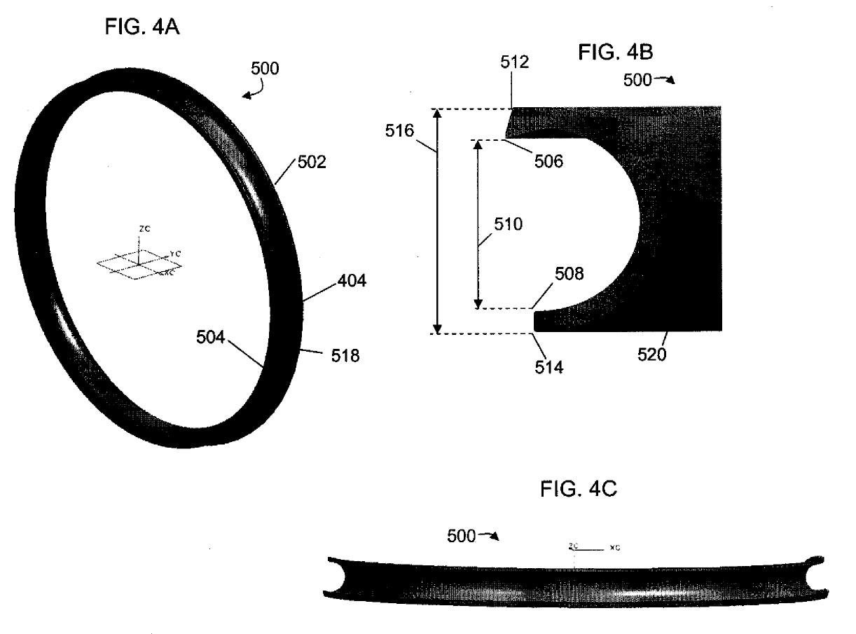

FIGS. 4A, 4B, and 4C are schematic diagrams of an exemplary quench ring rim 500 that may be used with a gasifier, such as gasifier 100 (shown in FIG. 1). In the exemplary embodiment, quench ring rim 500 is coupled to a quench ring flange (not shown). For example, in the exemplary embodiment, quench ring rim 500 is welded to the bottom (not shown) of the quench ring flange. Alternative embodiments may use other techniques to couple quench ring rim 500 to the quench ring flange. In the exemplary embodiment, quench ring rim 500 is semi- circular. In another embodiment, quench ring rim 500 has a C-shaped cross-sectional profile. Alternatively, quench ring rim 500 may have any annular shape that enables rim 500 to facilitate syngas cooling, as described herein. Quench ring rim 500 includes a first edge 502 and a second edge 504. In the exemplary embodiment, the radial distance from the bottom 506 of first edge 502 to the top 508 of second edge 504 defines an inner diameter 510 of quench ring rim 500. In the exemplary embodiment, inner diameter 510 is substantially identical to pipe inner diameter 410 (shown in FIG. 3). Moreover, the radial distance from the top 512 of first edge 502, to the bottom 514 of second edge 504 defines an outer diameter 516 of quench ring rim 500. In the exemplary embodiment, outer diameter 516 is substantially identical to pipe outer diameter 412 (shown in FIG. 3). In alternative embodiments, inner diameter 510 and outer diameter 516 of quench ring rim 500 are different from pipe inner diameter 410 and pipe outer diameter 412, respectively. In the exemplary embodiment, ring outer diameter 516 is between nine and forty inches. In a more preferred embodiment, ring outer diameter 516 is between twenty and thirty-eight inches. An inner radius (not shown) of the semi-circular quench ring rim 500 may be between 1.25 and 2 inches. Alternatively, quench ring rim 500 may be fabricated into any dimensions that facilitate syngas cooling as described herein. Quench ring rim 500 also includes an inner surface 518 and an outer surface 520.

During operation, quench ring rim 500 distributes a film of water around an inner surface (not shown) of a dip tube (not shown) and/or quench section 106 (as shown in FIG. 1). The film of water ensures that the surface remains wet to facilitate preventing slag from attaching to the inner surface and/or forming deposits along the inner surface. Moreover, the continuous film of water facilitates protecting dip tube and/or quench section 106 from heat damage from exposure to the hot syngas as it flows, for example, from the exit of a gasifier reaction vessel 116 (shown in FIG. 1).

The above-described methods and apparatus facilitate reducing the time and materials necessary for fabricating a quench ring rim for use in a gasification system. Use of a straight pipe having desired dimensions facilitates reducing material waste compared to the use of a forged billet which requires material on the inner diameter billet to be scraped out and discarded during fabrication of a quench ring rim. The ability to reduce the time and materials necessary for fabricating a quench ring rim facilitates reducing the cost of manufacturing a gasification system.

Exemplary embodiments of methods and apparatus that facilitate fabricating a quench ring rim are described above. The methods and apparatus are not limited to the specific embodiments described herein, but rather, components of the methods and apparatus may be utilized independently and separately from the other components described herein. For example, the method of fabrication used to form the quench ring rim for use in a power plant may also be completed and/or used in combination with other industrial plant or component design and monitoring systems and methods, and is not limited to practice with only power plants as described herein. Rather, the present invention can be implemented and utilized in connection with many other component or plant designs and monitoring applications.

While the invention has been described in terms of various specific embodiments, those skilled in the art will recognize that the invention can be practiced with modification within the spirit and scope of the claims.

What is claimed is:

1. A method for fabricating a rim for use in a gasification system, said method comprising:
providing a hollow pipe;
forming the pipe into a circular pipe, wherein a first end of the pipe is coupled to an opposite second end of the pipe; and
cutting the pipe to form a rim having a desired circumference.

2. A method in accordance with claim 1 further comprising sealing the first end and the second end of the straight pipe during formation of the circular pipe.

3. A method in accordance with claim 2 wherein sealing the first end and the second end of the straight pipe comprises sealing at least one of the ends of the pipe using a full penetration weld.

4. A method in accordance with claim 1 wherein forming the pipe into a circular pipe further comprises feeding the pipe through a pipe rolling machine.

5. A method in accordance with claim 1 further comprising heat treating the formed pipe and cooling the heat-treated pipe, wherein heat treating the formed pipe comprises:
mounting the formed pipe onto a fixture; and
exposing the formed pipe to a temperature between 1700° F. and 1900° F. for approximately 30 minutes.

6. A method in accordance with claim 1 wherein the rim comprises a metal alloy.

7. A method in accordance with claim 1 wherein the rim includes an inner radius, an outer radius, a first rim edge, a second rim edge, an inner surface, and an outer surface.

8. A method for fabricating a rim for use in a gasification system, said method comprising:
forming a hollow torroid by coupling a first end of a cylinder to a second opposite end of the cylinder, thereby defining an annular cavity within the torroid; and
cutting the torroid to form an annular rim having a C-shaped cross-sectional profile.

9. A method in accordance with claim 8 wherein forming a hollow torroid further comprises:
feeding the cylinder through a rolling machine; and
sealing the first end and second end of the cylinder.

10. A method in accordance with claim 9 wherein sealing the first end and the second end of the cylinder comprises sealing at least one of the ends of the cylinder using a full penetration weld.

11. A method in accordance with claim 8 further comprising heat treating the hollow torroid, wherein heat treating the torroid comprises:
mounting the torroid onto a fixture; and
exposing the torroid to a temperature between 1700° F. and 1900° F. for approximately 30 minutes.

12. A method in accordance with claim 11 further comprising cooling the heat-treated torroid.

13. A method in accordance with claim 8 wherein the rim comprises a metal alloy.

14. A method in accordance with claim 8 wherein the rim having a C-shaped cross-sectional profile includes an inner radius, an outer radius, a first rim edge, a second rim edge, an inner surface, and an outer surface.

15. A quench ring rim for use in a gasification system, said rim comprising:
an inner surface;
an outer surface opposite said inner surface;
a first rim edge;
a second rim edge;
an inner diameter defined by the radial distance between a bottom of said first rim edge and a top of said second rim edge; and
an outer diameter defined by the radial distance between a top of said first rim edge and a bottom of said second rim edge, wherein said rim is fabricated by:
providing a straight pipe having a desired length, diameter, and thickness;
forming the pipe into a circular pipe by feeding the pipe through a pipe rolling machine, wherein a first end of the pipe is joined to a second end of the pipe, and wherein the first and second ends are sealed; and
cutting the pipe along a desired circumference to form said rim having desired dimensions.

16. A quench ring rim in accordance with claim 15 wherein sealing the first end and the second end of the straight pipe comprises sealing at least one of the ends of the pipe using a full penetration weld.

17. A quench ring rim in accordance with claim 15 wherein the rim fabrication process further includes heat treating the circular pipe, heat treating the circular pipe includes:
mounting the pipe onto a fixture; and
exposing the pipe to a temperature between 1700° F. and 1900° F. for approximately 30 minutes.

18. A quench ring rim in accordance with claim 17 wherein the rim fabrication process further includes cooling the heat-treated pipe.

19. A quench ring rim in accordance with claim 15 wherein cutting the pipe along a desired circumference includes using a water-jet cutting process.

20. A quench ring rim according to claim 15 wherein said rim comprises a metal alloy.
